(19) United States
(12) Patent Application Publication
(10) Pub. No.: US 2007/0134462 A1
(43) Pub. Date: Jun. 14, 2007

(54) Storage media and associated method

(75) Inventors: Moitreyee Sinha, Clifton Park, NY (US); Irene Dris, Clifton Park, NY (US); Daniel Robert Olson, Voorheesville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/338,365

(22) Filed: Jan. 24, 2006

Related U.S. Application Data
(60) Provisional application No. 60/749,298, filed on Dec. 9, 2005.

(51) Int. Cl. B32B 3/02

(52) U.S. Cl. 428/64.6; 428/64.8; 428/65.1

(57) ABSTRACT

An optical storage medium is provided. The optical storage medium may include a light transmissive layer secured to the surface of a data layer and a curable hard coat layer secured to the surface of the light transmissive layer. The data layer may be read, written to, or both read and written to using a laser having a wavelength of less than about 650 nanometers. A method for securing a curable hard coat layer to a light transmissive layer, securing the light transmissive layer to a data layer and curing the hard coat layer is provided.

### CROSS REFERENCE TO RELATED APPLICATIONS

This application claims priority to and the benefit of provisional U.S. Patent Application No. 60/749,298, entitled “STORAGE MEDIA AND ASSOCIATED METHOD”, filed on Dec. 9, 2005, which is hereby incorporated by reference in its entirety.

### BACKGROUND

1. Technical Field

The invention may include embodiments that relate to an optical data storage medium. The invention may also include embodiments that relate to a method of making and using an optical data storage medium having a data layer and a curable hard coat layer.

2. Discussion of Related Art

An increase in data storage density in optical data storage media may be desirable to improve data storage technologies, such as, read-only media, write-once media, rewritable media, digital versatile disks (DVD), digital video recorders (DVR) and magneto-optical (MO) media.

As data storage densities increase in optical data storage media, optical disks with shorter reading and writing wavelengths may be needed. One example of a high-density recording medium may be digital video recording (DVR) media known in the industry as BLU-RAY DISC. DVR disk assemblies may include a data storage layer metallized onto a substrate and may be covered by an optical layer via a clear adhesive. Short reading and writing wavelengths may involve stringent design requirements for one or both of the optical layer and the substrate layer of the DVR disk assemblies.

Design requirements for the material used in optical data storage media may include one or more of dimensional stability, disk flatness (e.g., tilt), water strain, low birefringence, high transparency, heat resistance, ductility, high purity, or medium homogeneity (e.g., particulate concentration).

Currently employed materials may be lacking in one or more of these characteristics, and new materials and methods may be required in order to achieve properties other than those currently available for optical storage media.

### BRIEF DESCRIPTION

In one embodiment, an optical data storage medium may include a data layer, a light transmissive layer secured to the surface of a data layer, and a curable hard coat layer secured to the surface of the light transmissive layer. The data layer may be read, written to, or both read and written to using a laser having a wavelength of less than about 650 nanometers.

In one embodiment, an optical data storage medium may include a data layer; a light transmissive layer secured to the surface of a data layer, and a hard coat layer secured to the surface of the light transmissive layer. The hard coat layer may include a radiation curable or a thermally curable silicone composition. The data layer may be read, written to, or both read and written to using a laser having a wavelength of less than about 420 nanometers.

One embodiment may provide a method for securing a curable hard coat layer to a light transmissive layer, securing the light transmissive layer to a data layer and curing the hard coat layer.

### BRIEF DESCRIPTION OF DRAWING FIGURES

FIG. 1 is a cross-section of an optical data storage medium.

FIG. 2 is a cross-section of an optical data storage medium.

FIG. 3 is a cross-section of an optical data storage medium.

FIG. 4 is a plot of scratch area as a function of applied normal force for optical data storage media.

FIG. 5 is a plot of radial tilt change values at humidity of 90 percent over a period of time for optical data storage media.

### DETAILED DESCRIPTION

The invention may include embodiments that relate to an optical data storage medium. The optical data storage medium may have a data layer and a curable hard coat layer secured to the surface of the data layer. The invention may include embodiments that relate to a method of making and of using an optical data storage medium having a data layer and a curable hard coat layer.

In the following specification and the claims which follow, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

An optical data storage medium according to one embodiment may include a data layer and a curable hard coat layer secured to the surface of the data layer. The data layer may be read, written to, or both read and written to using a laser.

The data layer may function as an information or data-recording layer. The hard coat layer may function as the surface upon which the laser beam for recording or reproducing information or data is incident. The laser beam may be incident through the hard coat layer and other layers (if present) onto the data layer. The cured hard coat layer may improve one or more of dimensional stability, disk flatness (e.g., tilt), water strain, low birefringence, high transparency, heat resistance, and ductility of the optical storage medium.

The curable hard coat layer in one embodiment may include a thermally curable composition or a radiation curable composition. A thermally curable composition may include one or more of a siloxane, a melamine polyol, a urethane, an acrylate, an imide, or a combination of two or more thereof. In one embodiment, the hard coat layer may include a silicone resin. The hard coat layer may further include a catalyst.

The radiation used to cure the hard-coat layer may include one or more of ultra-violet radiation, electron-beam radiation, corona radiation or plasma. A radiation curable composition may include one or more of an acrylate, a urethane, an oxirane, a siloxane, or a combination of two or more thereof. The acrylate may be monomeric or polymeric and may be derived from one or more of an acrylic or a methacrylic monomer. In one embodiment, the hard coat layer may include a silicon-containing polyacrylate hard coat. The hard coat layer may further include a photoinitiator. In one embodiment, the hard coat layer may be free of a polycarbonate.

In one embodiment, the hard coat layer may include one or more additives. The additives may include one or more of flow control agents, modifiers, carrier solvents, viscosity modifiers, adhesion promoters, ultra-violet absorbers, or reinforcing fillers.

Suitable fillers may include metal compounds. Suitable metal compounds may include metal oxides, metal hydroxides, metal nitrides, mixed metal oxides, mixed metal nitrides, metal oxynitrides, mixed metal oxynitrides or a combination of two or more thereof. Suitable metal oxides or hydroxides may include one or more oxides, hydroxides, nitrides or oxynitrides of aluminum, magnesium, calcium, barium, boron, iron, zinc, zirconium, chromium, silicon, or titanium. In one embodiment, aluminum oxide (alumina) or hydroxide may be used as filler.

In one embodiment, the filler may include one or more of synthetic silicate, natural silicate, or glass fiber. Suitable examples of natural silicates may include kaolin, clay, or talc. Suitable examples of synthetic silicates may include aluminum silicate, magnesium silicate, calcium silicate, or combinations thereof.

In one embodiment, the filler may include one or more of a partially or fully condensed polyhedral oligosilsesquioxane (POSS). In one embodiment, the filler may include a fully condensed polyhedral oligosilsesquioxane, having formula (I);
(R¹SiO_{3/2})ₙ (I)
wherein “n” is an even integer from 2 to 100; and R¹ is independently at each occurrence a hydrogen atom, an aliphatic radical, n aromatic radical, or a cycloaliphatic radical.

Aliphatic radical, cycloaliphatic radical and aromatic radical may be defined as the following:

Aliphatic radical may be an organic radical having at least one carbon atom, a valence of at least one and may be a linear array of atoms. Aliphatic radicals may include heteroatoms such as nitrogen, sulfur, silicon, selenium and oxygen or may be composed exclusively of carbon and hydrogen. Aliphatic radical may include a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example, carboxylic acid derivatives such as esters and amides), amine groups, nitro groups and the like. For example, the 4-methylpent-1-yl radical may be a C₆ aliphatic radical comprising a methyl group, the methyl group being a functional group, which may be an alkyl group. Similarly, the 4-nitrobut-1-yl group may be a C₄ aliphatic radical comprising a nitro group, the nitro group being a functional group. An aliphatic radical may be a haloalkyl group that may include one or more halogen atoms, which may be the same or different. Halogen atoms include, for example; fluorine, chlorine, bromine, and iodine. Aliphatic radicals having one or more halogen atoms may include the alkyl halides: trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals may include allyl, aminocarbonyl (—CONH₂), carbonyl, dicyanoisopropylidene —CH₂C(CN)₂CH₂—), methyl (—CH₃), methylene (—CH₂—), ethyl, ethylene, formyl (—CHO), hexyl, hexamethylene, hydroxymethyl (—CH₂OH), mercaptomethyl (—CH₂SH), methylthio (—SCH₃), methylthiomethyl (—CH₂SCH₃), methoxy, methoxycarbonyl (CH₃OCO—), nitromethyl (—CH₂NO₂), thiocarbonyl, trimethylsilyl ((CH₃)₃Si—), t-butyldimethylsilyl, trimethoxysilylpropyl ((CH₃O)₃SiCH₂CH₂CH₂—), vinyl, vinylidene, and the like. By way of further example, a “C₁-C₃₀ aliphatic radical” contains at least one but no more than 30 carbon atoms. A methyl group (CH₃—) may be an example of a C₁ aliphatic radical. A decyl group (CH₃(CH₂)₉—) may be an example of a C₁₀ aliphatic radical.

A cycloaliphatic radical may be a radical having a valence of at least one, and having an array of atoms, which may be cyclic but which may not be aromatic. A cycloaliphatic radical may include one or more non-cyclic components. For example, a cyclohexylmethyl group (C₆H₁₁CH₂—) may be a cycloaliphatic radical, which may include a cyclohexyl ring (the array of atoms, which may be cyclic but which may not be aromatic) and a methylene group (the noncyclic component). The cycloaliphatic radical may include heteroatoms such as nitrogen, sulfur, selenium, silicon and oxygen, or may be composed exclusively of carbon and hydrogen. A cycloaliphatic radical may include one or more functional groups, such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like. For example, the 4-methylcyclopent-1-yl radical may be a C₆ cycloaliphatic radical comprising a methyl group, the methyl group being a functional group, which may be an alkyl group. Similarly, the 2-nitrocyclobut-1-yl radical may be a C₄ cycloaliphatic radical comprising a nitro group, the nitro group being a functional group. A cycloaliphatic radical may include one or more halogen atoms, which may be the same or different. Halogen atoms include, for example, fluorine, chlorine, bromine, and iodine. Cycloaliphatic radicals having one or more halogen atoms may include 2-trifluoromethylcyclohex-1-yl, 4-bromodifluoromethylcyclooct-1-yl, 2-chlorodifluoromethylcyclohex-1-yl, hexafluoroisopropylidene 2,2-bis (cyclohex-4-yl) (—C₆H₁₀C(CF₃)₂C₆H₁₀—), 2-chloromethylcyclohex-1-yl; 3-difluoromethylenecyclohex-1-yl; 4-trichloromethylcyclohex-1-yloxy, 4-bromodichloromethylcyclohex-1-ylthio, 2-bromoethylcyclopent-1-yl, 2-bromopropylcyclohex-1-yloxy (e.g. CH₃CHBrCH₂C₆H₁₀—), and the like. Further examples of cycloaliphatic radicals may include 4-allyloxycyclohex-1-yl, 4-aminocyclohex-1-yl (H₂NC₆H₁₀—), 4-aminocarbonylcyclopent-1-yl (NH₂COC₅H₈—), 4-acetyloxycyclohex-1-yl, 2,2-dicyanoisopropylidenebis(cyclohex-4-yloxy) (—OC₆H₁₀C(CN)₂C₆H₁₀O—), 3-methylcyclohex-1-yl, methylenebis(cyclohex-4-yloxy) (—OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl; hexamethylene-1,6-bis(cyclohex-4-yloxy) (—O C₆H₁₀(CH₂)₆C6H₁₀O—); 4-hydroxymethylcyclohex-1-yl (4-HOCH₂C₆H₁₀—), 4-mercaptomethylcyclohex-1-yl (4-HSCH₂C₆H₁₀—), 4-methylthiocyclohex-1-yl (4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g. (CH₃O)₃SiCH₂CH₂C₆H₁₀—), 4-vinylcyclohexen-1-yl, vinylidenebis(cyclohexyl), and the like. The term “a C₃-C₃₀ cycloaliphatic radical” may include cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

An aromatic radical may be an array of atoms having a valence of at least one and having at least one aromatic group. This may include heteroatoms such as nitrogen, sulfur, selenium, silicon and oxygen, or may be composed exclusively of carbon and hydrogen. Suitable aromatic radicals may include phenyl, pyridyl, furanyl, thienyl, naphthyl, phenylene, and biphenyl radicals. The aromatic group may be a cyclic structure having 4n+2 “delocalized” electrons where “n” may be an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical also may include non-aromatic components. For example, a benzyl group may be an aromatic radical, which may include a phenyl ring (the aromatic group) and a methylene group (the non-aromatic component). Similarly a tetrahydronaphthyl radical may be an aromatic radical comprising an aromatic group (C₆H₃) fused to a non-aromatic component —(CH₂)₄—. An aromatic radical may include one or more functional groups, such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical may be a C₇ aromatic radical comprising a methyl group, the methyl group being a functional group, which may be an alkyl group. Similarly, the 2-nitrophenyl group may be a C₆ aromatic radical comprising a nitro group, the nitro group being a functional group. Aromatic radicals include halogenated aromatic radicals such as trifluoromethylphenyl, hexafluoroisopropylidenebis(4-phen-1-yloxy) (—OPhC(CF₃)₂PhO—), chloromethylphenyl, 3-trifluorovinyl-2-thienyl, 3-trichloromethylphen-1-yl (3-CCl₃Ph—), 4-(3-bromoprop-1-yl)phen-1-yl (BrCH₂CH₂CH₂Ph—), and the like. Further examples of aromatic radicals may include 4-allyloxyphen-1-oxy, 4-aminophen-1-yl (H₂NPh—), 3-aminocarbonylphen-1-yl (NH₂COPh—), 4-benzoylphen-1-yl, dicyanoisopropylidenebis (4-phen-1-yloxy) (—OPhC(CN)₂PhO—), 3-methylphen-1-yl, methylenebis(phen-4-yloxy) (—OPhCH₂PhO—), 2-ethylphen-1-yl, phenylethenyl, 3-formyl-2-thienyl, 2-hexyl-5-furanyl; hexamethylene-1,6-bis(phen-4-yloxy) (—OPh(CH₂)₆PhO—), 4-hydroxymethylphen-1-yl (4-HOCH₂Ph—), 4-mercaptomethylphen-1-yl (4-HSCH₂Ph—), 4-methylthiophen-1-yl (4-CH₃SPh—), 3-methoxyphen-1-yl, 2-methoxycarbonylphen-1-yloxy (e.g., methyl salicyl), 2-nitromethylphen-1-yl (—PhCH₂NO₂), 3-trimethylsilylphen-1-yl, 4-t-butyldimethylsilylphenl-1-yl, 4-vinylphen-1-yl, vinylidenebis(phenyl), and the like. The term “a C₃-C₃₀ aromatic radical” may include aromatic radicals containing at least three but no more than 30 carbon atoms. A suitable C₃ aromatic radical may include 1-imidazolyl (C₃H₂N₂—). The benzyl radical (C₇H₇—) represents a C₇ aromatic radical.

In one embodiment, the fully condensed polyhedral oligosilsesquioxane (I) may include at least one of methyl silsesquioxane, phenyl silsesquioxane, phenylethyl silsesquioxane, or polyphenylsilsesquioxane. Methyl silsesquioxane exemplifies silsesquioxane of formula (I), wherein R¹ is a methyl radical. Phenyl silsesquioxane exemplifies silsesquioxane of formula (I), wherein R¹ is a phenyl radical. Phenylethyl silsesquioxane exemplifies silsesquioxane of formula (I), wherein R¹ is a phenylethyl radical. Phenyl polysilsesquioxane exemplifies silsesquioxane of formula (I), wherein R³ is a phenyl radical and “n” is greater than 20.

In one embodiment, the fully condensed polyhedral oligosilsesquioxane may include fully condensed polyhedral oligosilsesquioxane (POSS) frameworks comprising 6, 8, 10, or 12 Si atoms. The silsesquioxane framework may be built upon Si—O linkages and clusters. Some of the fully condensed polyhedral oligosilsesquioxane (POSS) frameworks exemplifying embodiments of the invention may include silsesquioxanes of formulae (II), (III), or (IV); 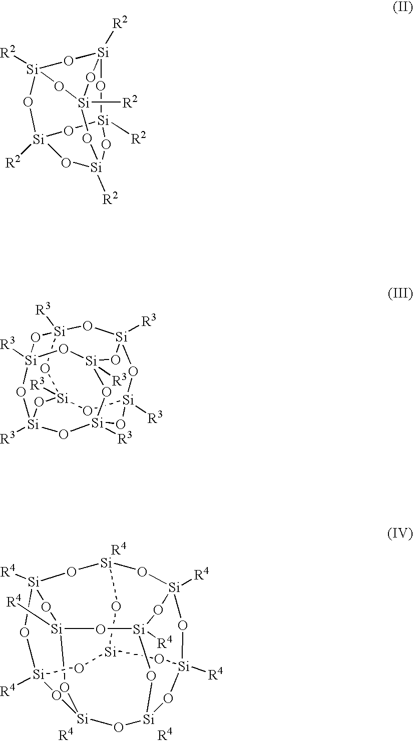
wherein R², R³ and R⁴ are independently at each occurrence a hydrogen atom, an aliphatic radical, an aromatic radical, or a cycloaliphatic radical.

In one embodiment, the inorganic filler may include a partially condensed polyhedral oligosilsesquioxane (POSS) having formula (V);
(R⁵SiO_{3/2})ₙ(O_{1/2}H)ₘ (V)
wherein “n” is an integer from 2 to 100: “m” is an integer from 0 to 100: with the proviso that the sum of n+m is an even integer; and R⁵ is independently at each occurrence a hydrogen atom, an aliphatic radical, an aromatic radical, or a cycloaliphatic radical. Formula (V) falls within general formula (I) and represents a special case wherein n is an even integer from 2 to 100 and m is 0.

In one embodiment, the partially condensed polyhedral oligosilsesquioxane (POSS) framework may include 4 to 12 Si atoms. The silsesquioxane framework may be built upon Si—O linkages and clusters. Some of the partially condensed polyhedral oligosilsesquioxane (POSS) frameworks exemplifying embodiments of the invention may include silsesquioxanes of formulae (VI), (VII), (VIII), or (IX); 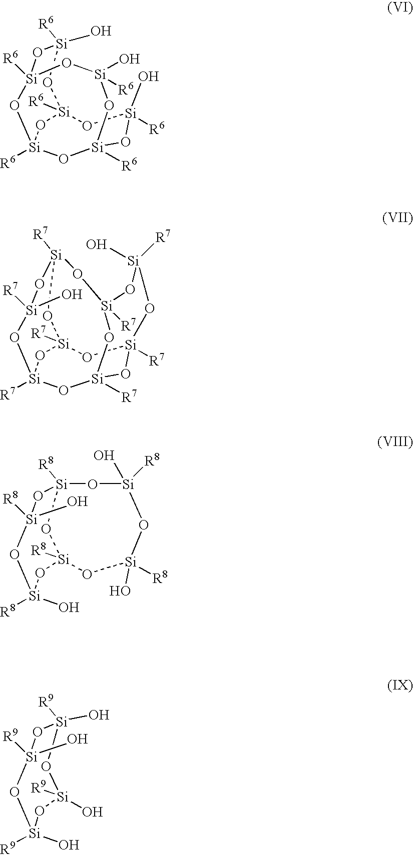
wherein R⁶, R⁷, R⁸ and R⁹ are independently at each occurrence a hydrogen atom, an aliphatic radical, an aromatic radical, or a cycloaliphatic radical.

Silsesquioxanes may be available commercially from Aldrich Chemical Co, Gelest Inc., or may be produced by base-catalyzed hydrolysis and condensation of alkyltrihalosilanes or alkyltrialkoxysilanes.

In one embodiment, silicon dioxide (silica) or hydroxide may be used as filler. The silica used may include precipitated silica, or pyrogenic silica. In one embodiment, the silica may be colloidal silica. In one embodiment, the inorganic filler may be modified at the surface with one or more of organo-silanes, organosilazanes, organo-titanates, organo-zirconates, betadiketones, carboxylic acids (e.g. citric acid), carboxylic acid salts (e.g. sodium citrate), thiols, or amines. In one embodiment, the hard coat may include compatibilized and functionalized silica. In one embodiment, a filler of silica may be treated with at least one organoalkoxysilane and at least one organosilazane. The two-component treatment may be done sequentially or may be done simultaneously. In sequential treatment, the organoalkoxysilane may be applied or reacted with at least a portion of active termination sites on the surface of the filler, and the organosilazane may be applied or reacted with at least a portion of the active termination sites that may remain after the reaction with the organoalkoxysilane.

After the reaction with the organoalkoxysilane, the otherwise phase incompatible filler may be relative more compatible or dispersible in an organic or non-polar liquid phase. Organoalkoxysilanes used to functionalize the colloidal silica may be included within the formula (X):
(R¹⁰)ₐSi(OR¹¹)₄₋ₐ (X)
where R¹⁰ may be independently at each occurrence an aliphatic radical, an aromatic radical, or a cycloaliphatic radical., optionally further functionalized with alkyl acrylate, alkyl methacrylate or an epoxide group, R¹¹ may be a hydrogen atom, an aliphatic radical, an aromatic radical, or a cycloaliphatic radical and “a” may be a whole number equal to 1 to 3 inclusive. The organoalkoxysilanes may include one or more of phenyl trimethoxy silane, 2-(3,4-epoxy cyclohexyl) ethyl trimethoxy silane, 3-glycidoxy propyl trimethoxy silane, or methacryloxy propyl trimethoxy silane.

Even though phase compatible with the pendant organic groups from the reaction with the organoalkoxysilane, residual active termination sites on the surface of the filler may initiate premature chemical reactions, may increase water absorption, may affect the transparency to certain wavelengths, or may have other undesirable side effects. In one embodiment, the phase compatible filler may be passivated by the capping of the active termination sites by a passivator or a passivating agent such as an organosilazane. Examples of organosilazanes may include one or more of hexamethyl disilazane (“HMDZ”), tetramethyl disilazane, divinyl tetramethyl disilazane, or diphenyl tetramethyl disilazane. The phase compatible, passivated filler may be admixed with a hard coat composition, and may form a stable filled hard coat system. The organoalkoxysilane and the organosilazane are examples of a phase compatibilizer and a passivator, respectively.

The hard coat layer may include an additive. An average particle size of the filler may be selected such that the hard coat layer may be substantially transparent. Substantially transparent may mean that a test sample of the hard coat material having a thickness of about 0.5 micrometer allows approximately 80 percent of incident electromagnetic radiation having wavelength in the range from about 290 nanometers to about 1200 nanometers at an incident angle less than about 10 degrees to be transmitted through the sample. In one embodiment, the hard coat may include an additive that may have a particle size less than about 100 nanometers. In one embodiment, the hard coat may include an additive that may have a particle size in a range of from about 0.5 nanometers to about 2.5 nanometers, from about 2.5 nanometers to about 10 nanometers, from about 10 nanometers to about 50 nanometers, or from about 50 nanometers to about 100 nanometers. In one embodiment, the hard coat may include an additive that may have a particle size less than about 0.5 nanometers. The thickness of the hard coat layer may vary depending upon the additional layers used as discussed later.

In one embodiment, the hard coat layer may include a thermally curable composition including a colloidal silica-filled-further curable organopolysiloxane composition. The composition may include a dispersion of colloidal silica in a lower aliphatic alcohol-water solution of the partial condensate of a silanol having formula (XI);
R¹²Si(OH)₃ (XI)
wherein R¹² may be an aliphatic radical. In one embodiment, R¹² may be a C₁-C₃ alkyl radical, a vinyl radical, a 3,3,3-trifluoropropyl radical, a gamma-glycidoxypropyl radical, or a gamma-methacryloxypropyl radical, with at least 70 percent by weight of the silanol being CH₃Si(OH)₃.

The composition may contain from about 10 to about 50 percent by weight of solids. The solids may include a mixture of from about 10 to about 70 percent by weight of colloidal silica and from about 30 to about 90 percent by weight of a partial condensate of a silanol. The partial condensate of a silanol, that is, a siloxanol, may be obtained, entirely from the condensation of CH₃Si(OH)₃ or may include a major portion which may be obtained from the condensation of CH₃Si(OH)₃ and a minor portion which may be obtained from the condensation of monoethyltrisilanol, monopropyltrisilanol, monovinyltrisilanol, mono gamma-methacryloxy-propyltrisilanol, mono gamma-glycidoxypropyltrisilanol, or mixtures thereof.

The composition may further include an acid to provide a pH in the range form about 3.0 to about 6.0. The pH may be maintained in this range in order to prevent premature gellation and increase the shelf life of the silica-filled organopolysiloxane hard coat composition and to obtain optimum properties in the cured coating. Suitable acids may include one or both of organic acid or inorganic acids. Suitable examples of acids may include, hydrochloric, chloroacetic, acetic, citric, benzoic, formic, propionic, maleic, oxalic, or glycolic acid. The acid may be added to either the silane, which hydrolyzes to form the silanol component of the composition, or the hydrosol prior to mixing the two components.

The trisilanol component of the hard coat composition may be generated in situ by the addition of the corresponding trialkoxysilanes to aqueous dispersions of colloidal silica. Suitable trialkoxysilanes may include one or more of methoxy, ethoxy, isopropoxy or t-butoxy substituents. Upon generation of the silanol in the acidic aqueous medium, there may be condensation of the hydroxyl substituents to form —Si—O—Si— bonding. The condensation may not be complete. The organopolysiloxane may retain an appreciable quantity of silicon-bonded hydroxyl groups, thus rendering the organopolysiloxane polymer soluble in the water-alcohol solvent. This soluble partial condensate may be characterized as a siloxanol polymer having at least one silicon-bonded hydroxyl group per every three —SiO— units. During curing of the hard coat composition, the residual hydroxyl groups may condense to form a silsesquioxane, R¹²SiO_{3/2}.

The silica component of the hard coat composition may be present in the form of colloidal silica. The particle size of the colloidal silica may be in the range from about 10 nanometers to about 30 nanometers. The silica-filled organopolysiloxane hard coat compositions may be prepared by adding trialkoxysilanes to colloidal silica hydrosol and adjusting the pH to a range of 3.0 to 6.0 by the addition of an acid. As mentioned, the acid may be added to either the silane or the silica hydrosol before the two components are mixed. Alcohol may be generated during the hydrolysis of the trialkoxy silanes to the trisilanols. Depending upon the percent solids desired in the final coating composition, additional alcohol, water, or a water-miscible solvent may be added. Suitable alcohols may the lower aliphatic alcohols such as methanol, ethanol, isopropanol, t-butanol, and mixtures thereof. The solvent system may contain from about 20 to about 75 weight percent alcohol to ensure solubility of the siloxanol formed by the condensation of the silanol. A minor amount of an additional water-miscible polar solvent such as acetone or butyl cellosolve may also be added to the water-alcohol solvent system. Alcohol or water-alcohol solvent may be added to give a composition having solids in the range from about from about 10 weight percent to about 50 weight percent. The solids may include from about 10 weight percent to about 70 weight percent of colloidal silica and from about 30 weight percent to about 90 weight percent of the partial condensate of the silanol.

The composition may be aged for a short period of time to ensure formation of the partial condensate of the silanol, that is, the siloxanol. This condensation may occur upon generation of the silanol in the acidic aqueous medium through the hydroxyl substituents to form Si—O—Si bonding. The condensation may not be complete, resulting in a siloxane having an appreciable quantity of silicon-bonded hydroxyl group. This aged, silica-filled further-curable organopolysiloxane hard coat composition may be then applied onto the data layer and then air dried to evaporate the volatile solvents from the top coat composition. Thereafter, heat may be applied to cure the hard coat. During curing, the residual hydroxyls of the siloxane may condense to give a silsesquioxane, R¹²SiO_{3/2}, resulting in a silica-filled cross-linked organo-polysiloxane hard coat.

The hard coat may contain silica in the range from about from about 10 weight percent to about 70 weight percent of the total composition. The hard coat may contain organopolysiloxane present as the silsesquioxane, R¹¹SiO_{3/2}, in the range from about 30 weight percent to about 90 weight percent of the total composition.

In one embodiment, the hard coat layer may include a ultra-violet radiation curable composition. The ultra-violet ray radiation curable composition may include colloidal silica, hydrolysis product of silyl acrylate of formula (XII), an acrylate monomer of formula (XII), and a photoinitiator. 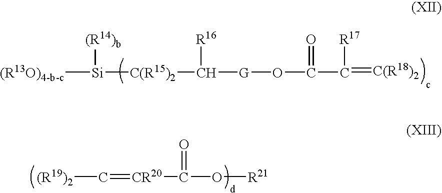
wherein R¹³ may be independently at each occurrence a monovalent aliphatic radical; R⁴-R²⁰ may be independently at each occurrence a hydrogen atom, an aliphatic radical, an aromatic radical, or a cycloaliphatic radical; R²¹ may be a polyvalent aliphatic radical, a polyvalent cycloaliphatic radical, or a polyvalent aromatic radical; G may be a divalent aliphatic radical; “b” may be a whole number equal to 0 to 2, “c” may be an integer equal to 1 to 3, with the proviso that “b”+“c” may be equal to 4; and “d” may be an integer equal to 2 to 4.

Colloidal silica may be present in an amount in an range from about 1 weight percent to about 60 weight percent of the total composition. Silyl acrylate may be present in an amount in an range from about 1 weight percent to about 50 weight percent of the total composition. Acrylate monomer may be present in an amount in an range from about 25 weight percent to about 90 weight percent of the total composition. UV photoinitiator may be present in an amount in an range from about 1 weight percent to about 5 weight percent of the total composition.

Colloidal silica may be available in either acidic or basic form. In one embodiment an acidic form of colloidal silica may be used. Alkaline colloidal silica may also be converted to acidic colloidal silica with additions of acids such as hydrochloric acid or sulfuric acid along with high agitation.

In one embodiment, the hard coat composition may include only one of the polyfunctional acrylate monomers. In one embodiment, the hard coat composition may include a mixture of two polyfunctional acrylate monomers, for example a diacrylate and a triacrylate. When the coating compositions contain a mixture of acrylate monomers, the ratio, by weight, of the diacrylate to the triacrylate may be in the range from about 10/90 to about 90/10. Suitable mixtures of diacrylate and triacrylates may include mixtures of hexanediol diacrylate with pentaerythritol triacrylate, hexanediol diacrylate with trimethylolpropane triacrylate, diethyleneglycol diacrylate with pentaerythritol triacrylate, or diethyleneglycol diacrylate with trimethylolpropane triacrylate.

The photoinitiator may include blends of ketone-type and hindered amine type materials. The weight fraction of the ketone compound to the hindered amine compound may be in the range from about 4/1 to about 1/4.

The photocurable hard coat compositions may also contain a photosensitizing amount of photoinitiator, that is, an amount effective to effect the photocure in a non-oxidizing atmosphere, for example, nitrogen, of the coating composition. The amount of photoinitiator may be in a range from about 0.01 weight percent to about 10 weight percent.

The hard coat composition may also optionally include UV absorbers or stabilizers such as resorcinol monobenzoate or 2-methyl resorcinol dibenzoate. The stabilizers may be present in an amount, based upon the weight of the coating composition, exclusive of any additional solvent, which may optionally be present, in the range from about 0.1 weight percent to about 15 weight percent.

The hard coat composition may be made by blending together one or more of the aqueous colloidal silica, the silyl acrylate, the polyfunctional acrylic monomer, the UV photosensitizer, and optionally any other additives. In one embodiment, the silyl acrylate may be hydrolyzed in the presence of aqueous colloidal silica and a water miscible alcohol. In one embodiment, the aqueous colloidal silica may be added to the silylacrylate, which has been hydrolyzed in aqueous alcohol. Suitable alcohols may include any water miscible alcohol, such as methanol, ethanol, propanol, butanol, ethoxyethanol, butoxyethanol, or methoxypropanol. In one embodiment, aqueous colloidal silica and the silylacrylate may be combined and stirred until hydrolysis has been effected. The hydrolysis of the silylacrylate may be accomplished at ambient conditions, or may be effected by heating the hydrolysis mixture to reflux for a few minutes.

In one embodiment, the hard coat material may be available from GE Plastics, Waterford, Mass. under the trade name of UV HC3000, UV HC8558, UV HC8556, SHC 5020, SHC 1200, PHC 587, AS4000, AS4700, or SBC400. In one embodiment, the hard coat may be available from SDC Coatings, Anaheim, Calif. under the trade name of MP1175UV, MP101, or PF1153.

The data storage medium may include a data layer. The data layer may be made of a material capable of storing retrievable data. The data or information which is to be stored on the data storage medium may be imprinted directly onto the surface of the data layer or may be stored in a photo-, thermal-, or magnetically-definable medium. The photo-, thermal- or magnetically-definable medium may be deposited onto the surface of a substrate layer to form the data layer. Suitable material for the data layer may include one or more of metal oxides (for example, silicone oxide), rare earth element-transition metal alloys, nickel, cobalt, chromium, tantalum, platinum, terbium, gadolinium, iron, boron, organic dyes (for example, cyanine or phthalocyanine type dyes), inorganic phase change compounds (for example, GeTeSb, TeSeSn, or InAgSb), alloys, or combinations comprising at least one of the foregoing. Suitable phase-change compound may include the phase-change chalcogenide alloys available from Energy Conversion Device, Inc. (ECD).

The thickness of a data layer may be greater than about 5 nanometers. In one embodiment, the thickness of a data layer may in the range from about 5 nanometers to about 10 nanometers, from about 10 nanometers to about 25 nanometers, from about 25 nanometers to about 50 nanometers, from about 50 nanometers to about 100 nanometers. In one embodiment, the thickness of a data layer may be greater than about 100 nanometers.

The data storage layer may be applied to the disk substrate by a sputtering process, electroplating, coating techniques (spin coating, spray coating, vapor deposition, screen printing, painting, dipping, sputtering, vacuum deposition, electrodeposition, meniscus coating), or combinations thereof.

High areal densities may correspond to high data storage capabilities. Areal density may be increased by one or more of adding extra information layers or decreasing the laser beam spot diameter (i.e., the diameter of the laser light beam that strikes the media). The laser beam spot diameter may be approximately the wavelength of the laser light divided by the numerical aperture (NA) of the objective lens. The numerical aperture may be the measure of the light-gathering capacity of the lens system. Thus, the laser beam spot diameter may be decreased by one or more of decreasing the wavelength of the laser or increasing the NA of the objective lens. BLU-RAY DISC technology may be one example of a high areal density storage medium using a blue laser, also known as a blue-violet laser, having a 405 nanometers wavelength. In comparison, the wavelength of the laser used to read CDs is 780 nanometers.

In one embodiment, the data layer of the optical data storage medium may be read, written to, or both read and written to using a laser having a wavelength of less than about 650 nanometers. In one embodiment, the data layer of the optical data storage medium may be read, written to, or both read and written to using a laser having a wavelength of less than about 420 nanometers. In one embodiment, the data layer of the optical data storage medium may be read, written to, or both read and written to using a laser having a wavelength of about 405 nanometers. The hard coat layer may be transmissive to the laser beam and/or may interact with the laser beam to allow the data layer to be read, written to or both read and written to using a laser beam. The optical and physical characteristics of the hard coat layer that allow the data layer to be read, written to or both read and written to using a laser having a wavelength less than about 650 nanometers may be very different from that of a hard coat layer that allow the data layer to be read, written to or both read and written to using a laser having a wavelength less than about 420 nanometers.

In one embodiment, the NA of the objective lens of the laser beam source used to read, write to, or both read or write to the data layer may be greater than about 0.60. In one embodiment, the NA of the objective lens of the laser beam source used to read, write to, or both read or write to the data layer may be about 0.85.

In one aspect, an optical data storage medium may include a plurality of polymeric and/or metallic components, which may be combined in overlaying horizontal layers of various thicknesses, depending on the specific properties and requirements of the particular application of the optical data storage medium.

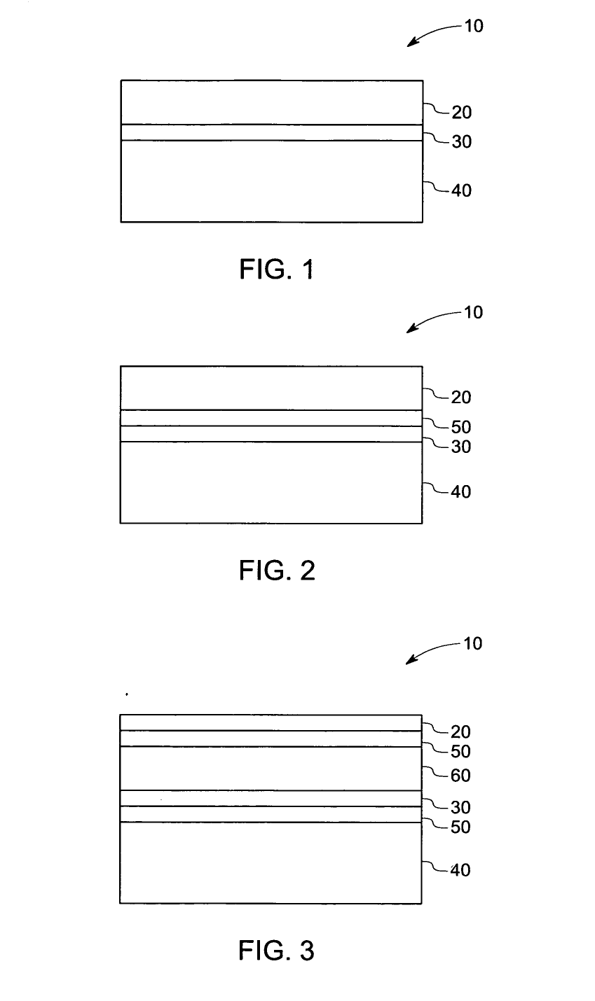

The optical data storage medium may include a hard coat layer directly in contact with a data layer. The data layer may be further secured to a substrate layer. The substrate layer may function as a supporting layer for the data layer and may provide rigidity to the optical storage medium. Referring to FIG. 1, an optical data storage medium 10 may include a hard coat layer 20 directly secured to a data layer 30, which may be secured to substrate layer 40.

The substrate layer may be made of a polymeric material, which may include one or both of a thermoplastic or a thermoset. The term “thermoplastic polymer” may refer to a material with a macromolecular structure that may repeatedly soften when heated and harden when cooled. The term “thermoset polymer” may refer to a material which may solidify when first heated under pressure, and which may not be remelted or remolded without destroying its original characteristics. Thermoplastic polymer and thermoset polymer may include one or both of addition or condensation polymers.

Suitable examples of thermoset polymers may include one or more of epoxides, melamines, phenolics, or ureas.

Suitable thermoplastic polymers may include one or more of olefin-derived polymers (for example, polyethylene, polypropylene, or their copolymers), polymethylpentane; diene-derived polymers (for example, polybutadiene, polyisoprene, or their copolymers), polymers of unsaturated carboxylic acids and their functional derivatives (for example, acrylic polymers such as poly(alkyl acrylates), poly(alkyl methacrylates), polyacrylamides, polyacrylonitrile or polyacrylic acid), alkenylaromatic polymers (for example, polystyrene, poly-alpha-methylstyrene, polyvinyltoluene, or rubber-modified polystyrenes), polyamides (for example, nylon-6, nylon-6,6, nylon-1,1, or nylon-1,2), polyesters; polycarbonates; polyester carbonates; polyethers (for example, polyarylene ethers, polyethersulfones, polyetherketones, polyetheretherketones, polyetherimides); polyarylene sulfides, polysulfones, polysulfidesulfones; or liquid crystalline polymers.

In one embodiment, the substrate layer may include a thermoplastic polyester. Suitable examples of thermoplastic polyesters may include one or more of poly(ethylene terephthalate), poly(1,4-butylene terephthalate), poly(1,3-propylene terephthalate), poly(cyclohexanedimethanol terephthalate), poly (cyclohexanedimethanol-co-ethylene terephthalate), poly(ethylene naphthalate), poly(butylene naphthalate), or polyarylates.

In another embodiment, the substrate layer may include a thermoplastic elastomeric polyester (TPE). A thermoplastic elastomer may be a material that may be processed as a thermoplastic material, but which may possess some of the properties of a thermoset. Suitable thermoplastic elastomeric polyesters may include one or more of polyetheresters containing soft-block segments of poly (alkylene oxide)(for example segments of poly(ethylene oxide) or poly(butylene oxide)); polyesteramides such as those synthesized by the condensation of an aromatic diisocyanate with dicarboxylic acids; or any polyester with a carboxylic acid terminal group.

In one embodiment, the substrate layer may include one or more of a homo-polycarbonate, a co-polycarbonate, or a co-polyester polycarbonate. In another embodiment, the substrate layer may include a blend of poly(arylene ether) and poly(alkenyl aromatic resins). Poly(arylene ether)s may include poly(phenylene ether) (PPE); poly(arylene ether) copolymers, poly(arylene ether) graft copolymers; poly(arylene ether) ether ionomers; block copolymers of alkenyl aromatic compounds, vinyl aromatic compounds, and poly(arylene ether); and combinations thereof. Poly(alkenyl aromatic) resins may include non-elastomeric block copolymers, for example diblock, triblock, and multiblock copolymers of styrene and a polyolefin. Non-elastomeric block copolymer compositions of styrene and butadiene may also be used that have linear block, radial block, or tapered block copolymer architectures. The poly(alkenyl aromatic) resins may also include block copolymers of styrene-polyolefin-methyl methacrylate.

The optical data storage medium may store data in a land and groove format with the data stored in the grooves or, alternatively, in both the grooves and the lands. The substrate of the optical storage medium may be molded to comprise the land and groove pattern. In one embodiment, the optical data storage medium may be prepared from a substrate having lands and grooves and appropriate data and hard coat layer capable of being read using a laser having a wavelength of less than about 650 nanometers. In one embodiment, the optical data storage medium may be prepared from a substrate having lands and grooves and appropriate data and hard coat layers capable of being read using a laser having a wavelength of less than about 420 nanometers.

In one embodiment, the substrate may have lands and grooves with a pitch in a range from about 0.05 micrometers to about 0.7 micrometers. As defined herein, the pitch may be measured from the center of the groove to the center of an adjacent groove. The dimension of the lands and grooves may be selected to provide the highest areal density depending upon the method of retrieving the data. In one embodiment, the width of the lands may be in the range from about 10 nanometers to about 200 nanometers. The height of the lands may be in range from about 10 nanometers to about 100 nanometers.

Methods that may be employed to produce the substrate layer may include injection molding, foaming processes, sputtering, plasma vapor deposition, vacuum deposition, electrodeposition, spin coating, solvent casting, spray coating, meniscus coating, data stamping, embossing, surface polishing, fixturing, laminating, rotary molding, two shot molding, coinjection, over-molding of film, microcellular molding, or combinations thereof.

In one embodiment, the method employed to produce the substrate layer may allow in-situ production of the substrate having the desired features, for example, lands and grooves. In one embodiment, the method employed to produce the substrate layer may include an injection molding-compression technique. The injection molding-compression technique may include filling a mold with a molten polymer or polymer blend used to produce the substrate. The mold may contain a preform or insert. The polymer system may be cooled. While still in at least a partially molten state, the polymer system may be compressed. The compression of the polymer system may result in imprinting the desired surface features, for example, pits and grooves, onto the desired portions of the substrate. The pits and grooves may be arranged in spiral, concentric or any other suitable orientation. The writing may occur on one or both sides of the substrate in the desired areas. The substrate may be cooled to room temperature. Once the substrate is produced, additional processing, such as electroplating, coating techniques (for example, spin coating, spray coating, vapor deposition, screen printing, painting, dipping, and the like), lamination, sputtering, or combinations thereof may be employed to dispose desired layers on the substrate

Optionally, disposed between the hard coat layer and the data storage layer, and/or between other layers, may be an adhesive layer that may, for example, adhere the hard coat layer to the other layers supported by the substrate. In one embodiment, an adhesive layer may secure the hard coat layer to the data layer. Referring to FIG. 2, an optical data storage medium 10 may include a hard coat layer 20 secured to a data layer 30 via an adhesive layer 50. The data layer 30 further may be secured to a substrate layer 40.

Suitable adhesive may include one or more of hot melt adhesives, ultraviolet ray-curable adhesives, heat curable adhesives, pressure sensitive adhesives or tacky type adhesives. Suitable material for the adhesive may include one or more of rubbers, flexible thermoplastics, or thermoplastic elastomer. Suitable examples of adhesive material may include one or more of natural rubber, silicone rubber, acrylic ester polymer, polyisoprene, styrene butadiene rubber, ethylene propylene rubber, fluoro vinyl methyl siloxane, chlorinated isobutene-isoprene, chloroprene, chlorinated polyethylene, chlorosulfonated polyethylene, urethane acrylate, epoxy, epoxy acrylate, polyester acrylate, butyl acrylate, expanded polystyrene, expanded polyethylene, expanded polypropylene, foamed polyurethane, plasticized polyvinyl chloride, dimethyl silicone polymers, methyl vinyl silicone, or polyvinyl acetate. The adhesive may optionally include a primer. In one embodiment, a pressure sensitive may be used in one or more adhesive layers of the optical storage medium.

The adhesive layer may be applied to the optical storage medium by methods such as vapor deposition, spin casting, solution deposition, injection molding, extrusion molding, or combinations thereof.

The adhesive layer may provide suitable optical properties required for the application in an optical data storage medium. Other properties that the adhesive layer may provide may include one or more of flexibility, creep resistance, resilience, elasticity, or dampening to enhance the quality of playback of the data storage disc. In one embodiment, the adhesive layer may be employed to enhance the dampening of the disc, with the thickness and nature of the adhesive determining the amount of dampening provided by the layer.

In one embodiment, the thickness of an adhesive layer may be greater than about 1 micrometers. In one embodiment, the thickness of an adhesive layer may in the range from about 1 micrometer to about 5 micrometers, from about 5 micrometers to about 10 micrometers, from about 10 micrometers to about 25 micrometers, or from about 25 micrometers to about 50 micrometers. In one embodiment, the thickness of an adhesive layer may be greater than about 50 micrometers.

Optionally, disposed between the hard coat layer and the data storage layer may be a light transmissive layer. The laser beam may be incident through the hard coat layer, the light transmissive layer and other layers (if present) onto the data layer. In one embodiment, an adhesive layer may secure the light transmissive layer to the data layer and the hard coat layer may be directly secured to the light transmissive layer. In one embodiment, an adhesive layer may secure the light transmissive layer to the data layer and another adhesive layer may secure the hard coat layer to the light transmissive layer. Referring to FIG. 3, an optical data storage medium 10 may include a hard coat layer 20 secured to a light transmissive layer 60 via an adhesive layer 50. The light transmissive layer may further be secured to a data layer 30 via another adhesive layer 50. The data layer 30 may be further secured to a substrate layer 40.

The light transmissive layer may include one or both of an active energy ray-curable material or a thermoplastic polycarbonate material. The active energy ray-curable material may include one or more of ultraviolet ray-curable materials, electron ray-curable materials, or gamma-ray curable materials.

Suitable active energy ray-curable material may include one or more of monomers, oligomers, or polymers having active-energy ray curable groups such as acrylic type double bonds (for example, acrylate, methacrylate, epoxy acrylate, urethane acrylate), allyl type double bonds (for example, diallyl phthalate) and unsaturated double bonds (for example, maleic acid derivatives). Suitable examples of monomers for active energy ray-curable materials may include one or more of styrene, ethyl acrylate, ethylene glycol diacrylate, ethylene glycol dimethacrylate, diethylene glycol diacrylate, diethylene glycol methacrylate, 1,6-hexanediol diacrylate, 1,6-hexanediol dimethacrylate, pentaerythritol tetra(meth)acrylate, pentaerythritol tri(meth)acrylate, trimethylolpropane tri(meth)acrylate, trimethylolpropane di(meth)acrylate, or (meth)acrylate of phenol ethylene oxide adduct.

In one embodiment, the light transmissive layer may include a thermoplastic polycarbonate material. The thermoplastic polycarbonate may have a structure of formula (XIV); 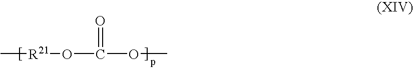
where “p” may be an integer from 10 to 10,000; and R²¹ may be a divalent aliphatic radical, a divalent aromatic radical, or a divalent cycloaliphatic radical. In some embodiments, R²¹ may be derived from a dihydroxy aliphatic compound, a dihydroxy cycloaliphatic compound or a dihydroxy aromatic compound. R²¹ may be a divalent aromatic radical derived from a dihydroxy aromatic compound having formula (XV); 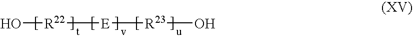
wherein R²² and R²³ may be independently at each occurrence an aromatic radical; E may be independently at each occurrence a bond, an aliphatic radical, a cycloaliphatic radical, an aromatic radical, a sulfur-containing linkage, a selenium-containing linkage, a phosphorus-containing linkage, or an oxygen atom; “t” may be a number greater than or equal to one; “v” may be either zero or one; and “u” may be a whole number including zero.

Suitable dihydroxy aromatic compound may include one or more of 1,1-bis(4-hydroxyphenyl)cyclopentane; 2,2-bis(3-allyl-4-hydroxyphenyl)propane; 2,2-bis(2-t-butyl-4-hydroxy-5-methylphenyl)propane; 2,2-bis(3-t-butyl-4-hydroxy-6-methylphenyl)propane; 2,2-bis(3-t-butyl4-hydroxy-6-methylphenyl)butane; 1,3-bis[4-hydroxyphenyl-1-(1-methylethylidine)]benzene; 1,4-bis[4-hydroxyphenyl-1-(1-methylethylidine)]benzene; 1,3-bis[3-t-butyl-4-hydroxy-6-methylphenyl-1-(1-methylethylidine)]benzene; 1,4-bis[3-t-butyl-4-hydroxy-6-methylphenyl-1-(1-methylethylidine)]benzene; 4,4′-biphenol; 2,2′,6,8-tetramethyl-3,3′,5,5′-tetrabromo-4,4′-biphenol; 2,2′,6,6′-tetramethyl-3,3′,5-tribromo-4,4′-biphenol; 1,1-bis(4-hydroxyphenyl)-2,2,2-trichloroethane; 2,2-bis(4-hydroxyphenyl-1,1,1,3,3,3-hexafluoropropane); 1,1-bis(4-hydroxyphenyl)-1-cyanoethane; 1,1-bis(4-hydroxyphenyl)dicyanomethane; 1,1-bis(4-hydroxyphenyl)-1-cyano-1-phenylmethane; 2,2-bis(3-methyl-4-hydroxyphenyl)propane; 1,1-bis(4-hydroxyphenyl)norbornane; 9,9-bis(4-hydroxyphenyl)fluorene; 3,3-bis(4-hydroxyphenyl)phthalide; 1,2-bis(4-hydroxyphenyl)ethane; 1,3-bis(4-hydroxyphenyl)propenone; bis(4-hydroxyphenyl) sulfide; 4,4′-oxydiphenol; 4,4-bis(4-hydroxyphenyl)pentanoic acid; 4,4-bis(3,5-dimethyl-4-hydroxyphenyl)pentanoic acid; 2,2-bis(4-hydroxyphenyl) acetic acid; 2,4′-dihydroxydiphenylmethane; 2-bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane (bisphenol-A); 1,1-bis(4-hydroxyphenyl)propane; 2,2-bis(3-chloro-4-hydroxyphenyl)propane; 2,2-bis(3-bromo-4-hydroxyphenyl)propane; 2,2-bis(4-hydroxy-3-methylphenyl)propane; 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 2,2-bis(3,5-dichloro-4-hydroxyphenyl)propane; 2,2-bis(3,5-dibromo-4-hydroxyphenyl)propane; 2,2-bis(3,5-dimethyl-4-hydroxyphenyl)propane; 2,2-bis(3-chloro-4-hydroxy-5-methylphenyl)propane; 2,2-bis(3-bromo-4-hydroxy-5-methylphenyl)propane; 2,2-bis(3-chloro-4-hydroxy-5-isopropylphenyl)propane; 2,2-bis(3-bromo-4-hydroxy-5-isopropylphenyl)propane; 2,2-bis(3-t-butyl-5-chloro-4-hydroxyphenyl)propane; 2,2-bis(3-bromo-5-t-butyl-4-hydroxyphenyl)propane; 2,2-bis(3-chloro-5-phenyl-4-hydroxyphenyl)propane; 2,2-bis(3-bromo-5-phenyl-4-hydroxyphenyl)propane; 2,2-bis(3,5-disopropyl-4-hydroxyphenyl)propane; 2,2-bis(3,5-di-t-butyl-4-hydroxyphenyl)propane; 2,2-bis(3,5-diphenyl-4-hydroxyphenyl)propane; 2,2-bis(4-hydroxy-2,3,5,6-tetrachlorophenyl)propane; 2,2-bis(4-hydroxy-2,3,5,6-tetrabromophenyl)propane; 2,2-bis(4-hydroxy-2,3,5,6-tetramethylphenyl)propane; 2,2-bis(2,6-dichloro-3,5-dimethyl-4-hydroxyphenyl)propane; 2,2-bis(2,6-dibromo-3,5-dimethyl-4-hydroxyphenyl)propane; 2,2-bis(4-hydroxy-3-ethylphenyl)propane; 2,2-bis(4-hydroxy-3,5-dimethylphenyl)propane; 2,2-bis(3,5,3′,5′-tetrachloro-4,4′-dihydroxyphenyl)propane; 1,1-bis(4-hydroxyphenyl)cyclohexylmethane; 2,2-bis(4-hydroxyphenyl)-1-phenylpropane; 1,1-bis(4-hydroxyphenyl)cyclohexane; 1,1-bis(3-chloro-4-hydroxyphenyl)cyclohexane; 1,1-bis(3-bromo-4-hydroxyphenyl)cyclohexane; 1,1-bis(4-hydroxy-3-methylphenyl)cyclohexane; 1,1-bis(4-hydroxy-3-isopropylphenyl)cyclohexane; 1,1-bis(3-t-butyl-4-hydroxyphenyl)cyclohexane; 1,1-bis(3-phenyl-4-hydroxyphenyl)cyclohexane; 1,1-bis(3,5-dichloro-4-hydroxyphenyl)cyclohexane; 1,1-bis(3,5-dibromo-4-hydroxyphenyl)cyclohexane; 1,1-bis(3,5-dimethyl-4-hydroxyphenyl)cyclohexane; 4,4′-[1-methyl-4-(1-methyl-ethyl)-1,3-cyclohexandiyl]bisphenol (1,3 BHPM); 4-[1-[3-(4-hydroxyphenyl)-4-methylcyclohexyl]-1-methyl-ethyl]-phenol (2,8 BHPM); 3,8-dihydroxy-5a,10b-diphenylcoumarano-2′,3′,2,3-coumarane (DCBP); 2-phenyl-3,3-bis(4-hydroxyphenyl)phthalimidine; 1,1-bis(3-chloro-4-hydroxy-5-methylphenyl)cyclohexane; 1,1-bis(3-bromo-4-hydroxy-5-methylphenyl)cyclohexane; 1,1-bis(3-chloro-4-hydroxy-5-isopropylphenyl)cyclohexane; 1,1-bis(3-bromo-4-hydroxy-5-isopropylphenyl)cyclohexane; 1,1-bis(3-t-butyl-5-chloro-4-hydroxyphenyl)cyclohexane; 1,1-bis(3-bromo-5-t-butyl-4-hydroxyphenyl)cyclohexane; 1,1-bis(3-chloro-5-phenyl-4-hydroxyphenyl)cyclohexane; 1,1-bis(3-bromo-5-phenyl-4-hydroxyphenyl)cyclohexane; 1,1-bis(3,5-disopropyl-4-hydroxyphenyl)cyclohexane; 1,1-bis(3,5-di-t-butyl-4-hydroxyphenyl)cyclohexane; 1,1-bis(3,5-diphenyl-4-hydroxyphenyl)cyclohexane; 1,1-bis(4-hydroxy-2,3,5,6-tetrachlorophenyl)cyclohexane; 1,1-bis(4-hydroxy-2,3,5,6-tetrabromophenyl)cyclohexane; 1,1-bis(4-hydroxy-2,3,5,6-tetramethylphenyl)cyclohexane; 1,1-bis(2,6-dichloro-3,5-dimethyl-4-hydroxyphenyl)cyclohexane; 1,1-bis(2,6-dibromo-3,5-dimethyl-4-hydroxyphenyl)cyclohexane; 1,1-bis(4-hydroxyphenyl)-3,3,5-trimethylcyclohexane; 1,1-bis(3-chloro-4-hydroxyphenyl)-3,3,5-trimethylcyclohexane; 1,1-bis(3-bromo-4-hydroxyphenyl)-3,3,5-trimethylcyclohexane; 1,1-bis(4-hydroxy-3-methylphenyl)-3,3,5-trimethylcyclohexane; 1,1-bis(4-hydroxy-3-isopropylphenyl)-3,3,5-trimethylcyclohexane; 1,1-bis(3-t-butyl-4-hydroxyphenyl)-3,3,5-trimethylcyclohexane; 1,1-bis(3-phenyl-4-hydroxyphenyl)-3,3,5-trimethylcyclohexane; 1,1-bis(3,5-dichloro-4-hydroxyphenyl)-3,3,5-trimethylcyclohexane; 1,1-bis(3,5-dibromo-4-hydroxyphenyl)-3,3,5-trimethylcyclohexane; 1,1-bis(3,5-dimethyl-4-hydroxyphenyl)-3,3,5-trimethylcyclohexane; 1,1-bis(3-chloro-4-hydroxy-5-methylphenyl)-3,3,5-trimethylcyclohexane; 1,1-bis(3-bromo-4-hydroxy-5-methylphenyl)-3,3,5-trimethylcyclohexane; 1,1-bis(3-chloro-4-hydroxy-5-isopropylphenyl)-3,3,5-trimethylcyclohexane; 1,1-bis(3-bromo-4-hydroxy-5-isopropylphenyl)-3,3,5-trimethylcyclohexane; 1,1-bis(3-t-butyl-5-chloro-4-hydroxyphenyl)-3,3,5-trimethylcyclohexane; 1,1-bis(3-bromo-5-t-butyl-4-hydroxyphenyl)-3,3,5-trimethylcyclohexane; bis(3-chloro-5-phenyl-4-hydroxyphenyl)-3,3,5-trimethylcyclohexane; 1,1-bis(3-bromo-5-phenyl-4-hydroxyphenyl)-3,3,5-trimethylcyclohexane; 1,1-bis(3,5-disopropyl-4-hydroxyphenyl)-3,3,5-trimethylcyclohexane; 1,1-bis(3,5-di-t-butyl-4-hydroxyphenyl)-3,3,5-trimethylcyclohexane; 1,1-bis(3,5-diphenyl-4-hydroxyphenyl)-3,3,5-trimethylcyclohexane; 1,1-bis(4-hydroxy-2,3,5,6-tetrachlorophenyl)-3,3,5-trimethylcyclohexane; 1,1-bis(4-hydroxy-2,3,5,6-tetrabromophenyl)-3,3,5-trimethylcyclohexane; 1,1-bis(4-hydroxy-2,3,5,6-tetramethylphenyl)-3,3,5-trimethylcyclohexane; 1,1-bis(2,6-dichloro-3,5-dimethyl-4-hydroxyphenyl)-3,3,5-trimethylcyclohexane; 1,1-bis(2,6-dibromo-3,5-dimethyl-4-hydroxyphenyl)-3,3,5-trimethylcyclohexane; 4,4-bis(4-hydroxyphenyl)heptane; 1,1-bis(4-hydroxyphenyl)decane; 1,1-bis(4-hydroxyphenyl)cyclododecane; 1,1-bis(3,5-dimethyl-4-hydroxyphenyl)cyclododecane; 4,4′dihydroxy-1,1-biphenyl; 4,4′-dihydroxy-3,3 ′-dimethyl-1,1-biphenyl; 4,4′-dihydroxy-3,3′-dioctyl-1,1-biphenyl; 4,4′-(3,3,5-trimethylcyclohexylidene)diphenol; 4,4′-bis(3,5-dimethyl)diphenol; 4,4′-dihydroxydiphenylether; 4,4′-dihydroxydiphenylthioether; 1,3-bis(2-(4-hydroxyphenyl)-2-propyl)benzene; 1,3-bis(2-(4-hydroxy-3-methylphenyl)-2-propyl)benzene; 1,4-bis(2-(4-hydroxyphenyl)-2-propyl)benzene; 1,4-bis(2-(4-hydroxy-3-methylphenyl)-2-propyl)benzene; 2,4′-dihydroxyphenyl sulfone; 4,4′-dihydroxydiphenylsulfone (BPS); bis(4-hydroxyphenyl)methane; 2,6-dihydroxy naphthalene; hydroquinone; resorcinol; C₁₋₃ alkyl-substituted resorcinols; 3-(4-hydroxyphenyl)-1,1,3-trimethylindan-5-ol; 1-(4-hydroxyphenyl)-1,3,3-trimethylindan-5-ol; 4,4-dihydroxydiphenyl ether; 4,4-dihydroxy-3,3-dichlorodiphenylether; 4,4-dihydroxy-2,5-dihydroxydiphenyl ether; 4,4-thiodiphenol; 2,2,2′,2′-tetrahydro-3,3,3′,3′-tetramethyl-1,1′-spirobi [1H-indene]-6,6′-diol; and mixtures of two or more thereof.

A suitable dihydroxy aromatic compound may include a bisphenol having structure of formula (XVI): 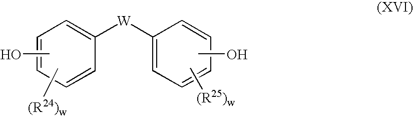
wherein R²⁴ and R²⁵ may independently be at each occurrence a halogen atom, a nitro group, a cyano group, an aliphatic radical, a cycloaliphatic radical, or an aromatic radical; “w” may be independently at each occurrence an integer from 0 to 4; and W may be a bond, an aliphatic radical, a cycloaliphatic radical, or an aromatic radical.

Representative units of structure (II) may include 1,1-bis(4-hydroxy-3-methylphenyl)cyclohexane (DMBPC); 1,1-bis(4-hydroxy-3-methylphenyl)cyclopen; 1,1-bis(4-hydroxy-3-methylphenyl)cycloheptane; 1,1-bis(4-hydroxy-3-methylphenyl)-3,3,5-trimethylcyclohexane (DMBPI); 2,2-bis(4-hydroxy-3-methyl)propane (DMBPA); 4, 4′-(1-phenylethylidene)bis(2-methylphenol) (DMbisAP); or combinations thereof.

In one embodiment, R²¹ of formula (XIV) may be derived from bisphenol A (2,2-bis(4-hydroxyphenyl)propane, CAS No. 80-05-7) and the thermoplastic polymeric material may be a Bisphenol A polycarbonate. Bisphenol A may be available commercially from ALDRICH Chemical Co. Bisphenol A polycarbonate may fall within generic formula (XIV) and represents the case wherein R²¹ may be derived from a bisphenol having formula (XVI), wherein “w” in formula (XVI) may be equal to 0, W may be an isopropylidene radical, and the hydroxyl groups may be present at the 4,4′ positions. Examples of other polycarbonates which may be suitable for use in the light transmissive layer may include, for example, 2,2′-dimethylbisphenol Z polycarbonate, 2,2′ dimethylbisphenol A polycarbonate, or bisphenol M polycarbonate.

Methods for preparation of polycarbonates may include one or more of interfacial polymerization using for example, phosgene; a bischloroformate polymerization method using, for example, bisphenol A bischloroformate; and a melt polymerization method using, for example, bisphenol A and a diaryl carbonate, such as diphenyl carbonate.

In one embodiment, the light transmitting layer may have one or more of optically transparency, low optical absorption or reflection in the laser wavelength range to be used, low birefringence, low thickness non-uniformity, or low surface roughness. In one embodiment, the light transmissive layer may have optical properties such as in-plane retardation of 20 nanometers and lower. “In-plane retardations” as used herein refers to a measure of the birefringence in the optical layer. In one embodiment, for a 100 micrometer thick light transmissive layer, thickness uniformity at length scales longer than 2 centimeters may be on the order of less than 2 micrometers. In one embodiment, for a 100 micrometer thick light transmissive layer, the surface roughness at the 1 millimeter length scale may be on the order of 40 nanometers or less.

The light transmissive layer may be deposited by vapor deposition (for example, plasma enhanced chemical vapor deposition, and the like), coating (e.g., electrodeposition coating, meniscus coating, spray coating, extrusion coating, spin coating, solution coating, and the like), casting (e.g., extrusion casting, solution casting, and the like), injection molding, film blowing, calendaring, or combinations thereof. In one embodiment, solution casting may be used to produce the light transmissive layer.

In addition to the substrate, hard coat layer, data layer, and the light transmissive layer, the optical data storage medium may include other layers such as a lubrication layer, a reflective layer, a dielectric layer, print layer, electro-static layer, dissipative layer and others. Suitable lubricant layers may include fluoro compounds such as fluoro oils and greases.

Suitable reflective layers may include one or more aluminum, silver, gold, titanium, and alloys and mixtures comprising at least one of the foregoing. The thickness of the reflective metal layer may be such that it may be sufficient to reflect an amount of energy sufficient to enable data retrieval. In one embodiment, the thickness of the reflective layer may be greater than about 300 Angstroms. In one embodiment, the thickness of the reflective layer may be in a range from about 300 Angstroms to about 400 Angstroms, from about 400 Angstroms to about 500 Angstroms, from about 500 Angstroms to about 600 Angstroms, or from about 600 Angstroms to about 700 Angstroms. In one embodiment, the thickness of the reflective layer may be greater than about 700 Angstroms.

The dielectric layer, which may be secured on one or both sides of the data layer and may be employed as heat controllers. Dielectric layers may include one or more of nitrides (for example, silicon nitride, aluminum nitride, and others); oxides (e.g., aluminum oxide); carbides (for example, silicon carbide); or alloys and combinations comprising at least one of the foregoing.

As mentioned earlier, the thickness of the hard coat layer may vary depending upon the other layers present in the optical data storage medium. In one embodiment, a light transmissive layer may be present in addition to hard coat layer and the average thickness of the hard coat layer may be in a range less than about 10 micrometers. In one embodiment, the average thickness of the hard coat layer may be in a range from about 1 micrometer to about 2 micrometers, from about 2 micrometers to about 4 micrometers, or from about 5 micrometers to about 10 micrometers.

In one embodiment, the optical data storage medium may be free of a light transmissive layer and the average thickness of the hard coat layer may be in a range greater than about 80 micrometers. In one embodiment, the average thickness of the hard coat layer may be in a range from about 80 micrometers to about 90 micrometers, from about 90 micrometers to about 100 micrometers, from about 100 micrometers to about 125 micrometers, or from about 125 micrometers to about 150 micrometers.

In one embodiment, the curable hard coat layer of the optical data storage medium may be cured to form a cured hard coat layer. Curing may include exposure to one or both of heat or radiation. If cured by radiation, the curing may occur by exposure to one or more of ultra-violet radiation, gamma-ray radiation, electron-beam radiation, corona radiation, or plasma. Curing of the hard coat layer may result in change in one or more of birefringence, hardness, modulus, radial tilt change, scratch resistance or coefficient of friction of the hard coat layer.

In one embodiment, the cured hard coat layer may have an average birefringence of about 30 nanometers. In one embodiment, the cured hard coat layer may have an average birefringence in the range from about 10 nanometers to about 15 nanometers, from about 15 nanometers to about 20 nanometers, from about 20 nanometers to about 25 nanometers, or from about 25 nanometers to about 30 nanometers. In one embodiment, the cured hard coat layer may have an average birefringence less than about 30 nanometers.

In one embodiment, the cured hard coat layer may have an average hardness value greater than about 0.1 Giga Pascal measured at an indentation of 100 microNewtons. In one embodiment, the cured hard coat layer may have an average hardness value in range from about 0.1 Giga Pascal to about 0.2 Giga Pascals, from about 0.2 Giga Pascals to about 0.25 Giga Pascals, from about 0.25 Giga Pascals to about 0.3 Giga Pascals, or from about 0.3 Giga Pascals to about 0.4 Giga Pascals measured at an indentation of 100 microNewtons. In one embodiment, the cured hard coat layer may have an average hardness value greater than about 0.4 Giga Pascals, measured at an indentation of 100 microNewtons. In one embodiment, the cured hard coat layer may have an average pencil hardness value measured by ASTM 3363 of about 7H.

In one embodiment, the cured hard coat layer may have an average modulus value greater than about 0.2 Giga Pascal measured at an indentation of 100 microNewtons. In one embodiment, the cured hard coat layer may have an average modulus value in range from about 0.2 Giga Pascal to about 0.4 Giga Pascals, from about 0.4 Giga Pascals to about 0.6 Giga Pascals, from about 0.6 Giga Pascals to about 0.8 Giga Pascals, or from about 0.8 Giga Pascals to about 1 Giga Pascal measured at an indentation of 100 microNewtons. In one embodiment, the cured hard coat layer may have an average modulus value greater than about 1 Giga Pascal measured at an indentation of 100 microNewtons.

In one embodiment, the cured hard coat layer may have a scratch resistance that results in permanent plastic deformation (scratch area) of less than 0.04 square micrometers using a diamond tip of 1 micrometer radius at a normal force of 200 microNewtons. In one embodiment, the cured hard coat layer may have a scratch resistance that results in permanent plastic deformation (scratch area) in a range from about 0.01 square micrometers to about 0.02 square micrometers, from about 0.02 square micrometers to about 0.03 square micrometers, or from about 0.03 square micrometers to about 0.04 square micrometers, using a diamond tip of 1 micrometer radius at a normal force of 200 microNewtons. In one embodiment, the cured hard coat layer may have a scratch resistance that results in permanent plastic deformation (scratch area) of less than about 0.01 square micrometers, using a diamond tip of 1 micrometer radius at a normal force of 200 microNewtons. Scratch area may be defined as a product of a peak-peak width and peak-to-valley depth of a scratch.

In one embodiment, the cured hard coat layer may have a coefficient of friction that is in a range of less than about 0.4 at a normal force of 300 microNewtons. In one embodiment, the cured hard coat layer may have a coefficient of friction in range from about 0.1 to about 0.2, from about 0.2 to about 0.3, or from about 0.3 to about 0.4, at a normal force of 300 microNewtons. In one embodiment, the cured hard coat layer may have a coefficient of friction that is in a range of less than about 0.1 at a normal force of 300 microNewtons.

Minimizing the change in data disk media tilt as the optical data storage medium is exposed to various environmental conditions may be one of the factors affecting the retention of disk performance. As used herein, the term “tilt” may refer to the number of radial degrees by which a data storage medium bends on a horizontal axis, and may be measured as the vertical deviation at the outer radius of the storage medium. The radial tilt may be determined by measuring the deflection of a laser beam incident at some angle to the disk. From geometrical considerations the deflection of the laser beam may be equal to two times the radial tilt angle. This may be denoted as the radial deviation and is two times the tilt angle measured in degrees.

One or more of time, temperature, or humidity may play a role in affecting the tilt of a medium including layers of material that may exhibit differential rates of shrinkage or expansion when exposed to varying environmental conditions. Predictive tests for determining dimensional stability of a data disk assembly may be made by thermal aging the disk assembly at 80 degree Celsius. for a predetermined time followed by measuring the radial tilt. Another predictive test may include exposing the data disk assembly to ambient temperature, but cycling the level of humidity while measuring the disk tilt during the cycling process.

In one embodiment, the optical data storage medium may exhibit a radial tilt change value of less than about 0.5 degree measured at a radius of 55 millimeters after 96 hours at 80 degree Celsius. In one embodiment, the optical data storage medium may exhibit a radial tilt change in a range from about 0.1 degree to about 0.2 degree, from about 0.1 degree to about 0.2 degree, from about 0.2 degree to about 0.3 degree, from about 0.3 degree to about 0.4 degree, or from about 0.4 degree to about 0.5 degree, measured at a radius of 55 millimeters after 96 hours at 80 degree Celsius. In one embodiment, the optical data storage medium may exhibit a radial tilt change value of less than about 0.1 degree measured at a radius of 55 millimeters after 96 hours at 80 degree Celsius.

In one embodiment, the optical data storage medium may exhibit a radial tilt change value of less than about 0.35 degree measured at a radius of 55 millimeters after 10 hours in a 90 percent relative humidity environment. In one embodiment, the optical data storage medium may exhibit a radial tilt change in a range from about 0.1 degree to about 0.15 degree, from about 0.15 degree to about 0.2 degree, from about 0.2 degree to about 0.25 degree, from about 0.25 degree to about 0.3 degree, or from about 0.3 degree to about 0.35 degree, measured at a radius of 55 millimeters after 10 hours in a 90 percent relative humidity environment. In one embodiment, the optical data storage medium may exhibit a radial tilt change value of less than about 0.1 degree measured at a radius of 55 millimeters after 10 hours in a 90 percent relative humidity environment.

In one embodiment, an optical data storage medium may be provided. The optical data storage medium may include a data layer and a hard coat layer secured directly to a surface of the data layer. The hard coat layer may include a radiation curable or a thermally curable silicone composition. The hard coat layer may have an average thickness in a range of greater than about 80 micrometers. The data layer surface may be capable of being read, written to, or both read and written to using a laser that may have a wavelength of less than about 420 nanometers.

In one embodiment, an optical data storage medium may be provided. The optical data storage medium may include a data layer; a light transmissive layer disposed on the data layer; and a hard coat layer disposed on the light transmissive layer. The hard coat layer may include a radiation curable or a thermally curable silicone composition. The data layer surface may be read, written to, or both read and written to using a laser that may have a wavelength of less than about 420 nanometers.

Numerous methods may be employed to produce the optical data storage medium including one or more of injection molding, foaming processes, sputtering, plasma vapor deposition, vacuum deposition, electrodeposition, spin coating, solvent casting, spray coating, meniscus coating, data stamping, embossing, surface polishing, fixturing, laminating, rotary molding, two shot molding, coinjection, over-molding of film, microcellular molding, or combinations thereof.

In one embodiment, a method for securing a curable hard coat layer directly to a data layer may be provided. The method may further include curing the hard coat layer to form a cured hard coat layer and an optical data storage medium. The method may further include reading, writing to, or both reading and writing to the data layer using a laser having a wavelength of less than about 420 nanometers.

In one embodiment, a hard coat layer may be formed on a data layer by coating the aforementioned hard coat agent composition. The coating method may include one or more of spin coating, dip coating, spray coating, meniscus coating, solvent casting or gravure coating methods. The coating method may form an uncured hard coat layer, and this uncured layer may be then irradiated with active energy rays such as ultraviolet rays, electron rays or visible rays or heated to a specific temperature, thereby curing the uncured layer and forming the hard coat layer.

In one embodiment, the data layer further may be secured to a substrate layer. The data layer may be applied to the disk substrate by one or more of a sputtering process, electroplating, or coating techniques such as spin coating, spray coating, vapor deposition, screen printing, painting, dipping, sputtering, vacuum deposition, electrodeposition, or meniscus coating.

In one embodiment, a light transmissive layer may be included between the hard coat layer and the data layer. The method utilized to produce the light transmissive layer may include one or more of solution casting, extrusion casting, extrusion calendaring, spin coating, or injection molding.

Optionally, an adhesive layer may be present between the various layers of the optical data storage medium. The adhesive layer may include in the optical data storage medium by methods including one or more of vapor deposition, spin casting, solution deposition, injection molding, or extrusion molding.

The optical data storage medium may be shaped to allow for the medium to be affixed to a spindle and the data read while the medium may be spun about the spindle. In one embodiment, the medium may be disk shaped having a hole in the center for affixation to a spindle, and a circular outside diameter. Other shapes may also be used rather than circular, including, for example, square, star, octagonal, hexagonal, and the like. Currently, the dimensions of the storage medium are specified by the industry to enable their use in presently available data storage medium reading and writing devices. In one embodiment, the data storage medium may have an inner diameter in a range from about 15 millimeters to about 40 millimeters and an outer diameter in a range from about 65 millimeters to about 130 millimeters. Other possible dimensions may include an inner diameter in a range from about 1 millimeter to about 100 millimeters and an outer diameter in a range from about 5 millimeters to about 300 millimeters.

In one embodiment, the optical data storage medium may have a storage capacity of greater than about 22 gigabytes, greater than about 25 gigabytes, or greater than about 27 gigabytes per disk side. Accordingly, double-sided disks may have a storage capacity of greater than about 44 gigabytes, greater than about 50 gigabytes, or greater than about 54 gigabytes.

In one embodiment, the transfer rate of the data storage medium may be greater than about 25 megabytes per second, greater than about 30 megabytes per second, or greater than about 35 megabytes per second.

### EXAMPLES

The hard coats that may be used may include commercial hard coats available from GE Silicones under the tradenames of UV HC3000, UV HC8558, SHC 5020 and AS4000 or those available from SDC Coatings, Anaheim, Calif. under the trade name of MP1175U and PF1153.

### Comparative Example 1

An optical data storage medium is prepared from a 1.1 millimeter (mm) thick substrate made from bisphenol-A polycarbonate resin (OQ1050, Optical quality polycarbonate available from GE Plastics). A thin aluminum reflective data layer (0.05 micrometers to 0.10 micrometers) is sputtered onto the substrate layer. A pressure sensitive adhesive layer (approximately 25 micrometers in thickness) is applied to the metallized portion of the substrate followed by a light transmissive layer made from bisphenol-A polycarbonate (BPA-PC) (about 75 micrometers in thickness) using a nitto tape applicator manufactured by Record Products of America. The data disk assembly is completed by pressing the stack in a Carver laminator press at 60° C. and 80 pounds per square inch (psi; 5.6 kgf/cm²) for 5 minutes to fully bond the layers.

### Example 1

An optical data storage medium is prepared from a 1.1 millimeter (mm) thick substrate made from bisphenol-A polycarbonate resin (OQ1050, Optical quality polycarbonate available from GE Plastics). A thin aluminum reflective data layer (0.05 micrometers to 0.10 micrometers) is sputtered onto the substrate layer. A pressure sensitive adhesive layer (approximately 25 micrometers in thickness) is applied to the metallized portion of the substrate followed by a light transmissive layer made from bisphenol-A polycarbonate (BPA-PC) (about 75 micrometers in thickness) using a nitto tape applicator manufactured by Record Products of America. A hard coat layer made from UVHC3000 is spin coated onto the BPA-PC layer to form a hard coat layer. The thickness of the hard coat layer is the range from about 2 micrometers to about 3 micrometers. The speed of spin coating is varied in the range from about 400 rpm to about 2500 rpm depending upon the thickness required. The data disk assembly is completed by pressing the stack in a Carver laminator press at 60° C. and 80 pounds per square inch (psi; 5.6 kgf/cm²) for 5 minutes to fully bond the layers. The spin-coated medium is exposed to UV light to cure the hard coat at a dosage of 5-15 Joules/cm² with an intensity of 0.6-1.6 Watts/cm². The exposure is conducted using a 300-600 Watt Fusion Type H UV bulb for 1-2 minutes at 25 degrees Celsius followed by 2-6 minutes at 63-85 degrees Celsius.

### Example 2

In this example, the optical data storage medium is prepared in the same way as that in Example 1, except the hard coat layer is made from MP1175UV.

### Example 3

In this example, the optical data storage medium is prepared in the same way as that in Example 1, except the hard coat layer is made from UVHC8558.

### Example 4

In this example, the optical data storage medium is prepared in the same way as that in Example 1, except the hard coat layer is made from PF1153.

### Example 5

In this example, the optical data storage medium is prepared in the same way as that in Example 1, except the hard coat layer is made from AS4700.

### Example 6

In this example, the optical data storage medium is prepared in the same way as that in Example 1, except the hard coat layer is made from SHC5020.

Optical data storage medium fabricated in Comparative Example 1 and Examples 1-6 are tested to determine hardness, modulus, scratch resistance and coefficient of friction of the hard coat layer and radial tilt change of the optical data storage medium.

Table 1 shows the hardness and modulus values measured at an indentation of 0.1 milliNewtons for Comparative Example 1 and Examples 1, 2, and 3. Table 1 also shows the coefficient of friction values measured at a normal force of 0.3 milliNewtons for Comparative Example 1 and Examples 1, 2, and 3. The optical storage media with hard coat shows higher values of hardness and modulus and lower values of coefficient of friction.

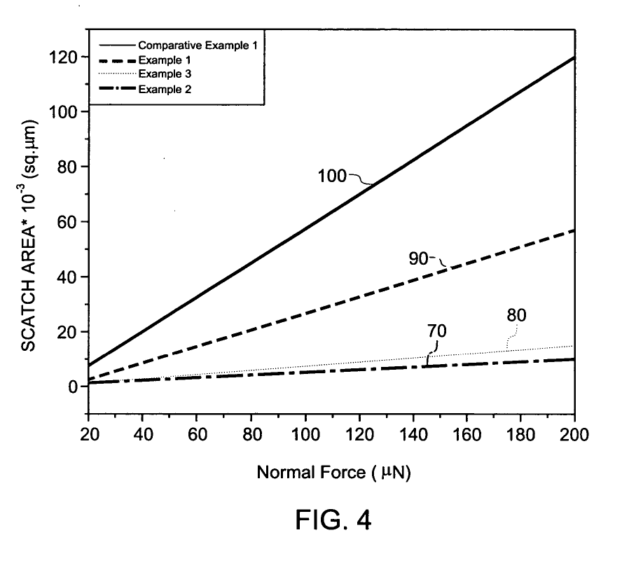

FIG. 4 shows the scratch area obtained by varying the normal force for Comparative Example 1 (curve 100) and Examples 1, 2 and 3 (curves 70, 80 and 90). At all values of normal forces the scratch area is lower for optical storage media with a hard coat layer.

TABLE 1

| Example | Hardness (GPa) | Modulus (GPa) | Coeff. Fric |
|---|---|---|---|
| Comparative Example 1 | 0.2129 | 2.9099 | 0.483 |
| Example 1 | 0.4059 | 4.0850 | 0.295 |
| Example 2 | 0.4486 | 3.8155 | 0.228 |
| Example 3 | 0.4132 | 4.5167 | 0.259 |

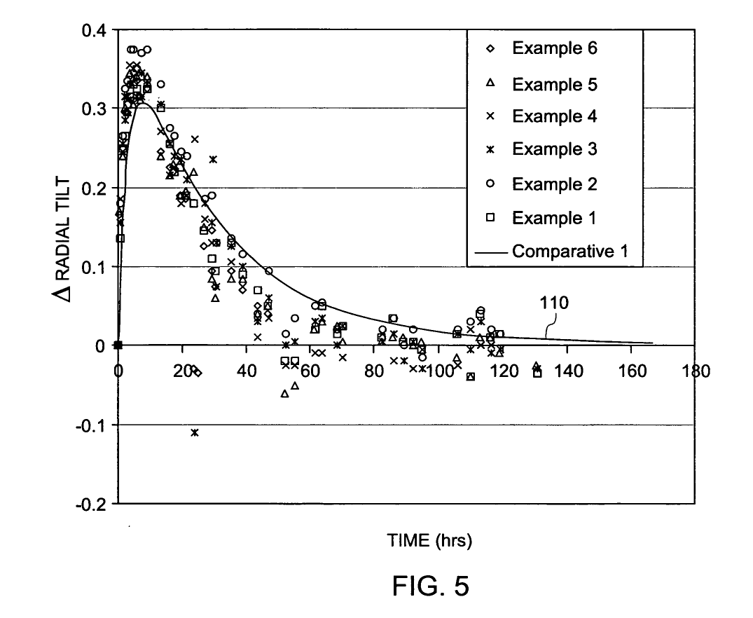

The optical data storage media of Comparative Example 1 and Examples 1-6 are equilibrated in an environment of a humidity of about 50 percent. Data storage disks are transferred from this first environment of an initial humidity of about 50 percent, to a second environment with humidity of about 90 percent. The tilt of the data storage disks is measured over time at a radius of 55 mm while the disk equilibrated in the 90 percent humidity. FIG. 5 shows the radial tilt change values for Comparative Example 1 (curve 110) and Examples 1-6 at humidity of 90 percent over a period of time

The foregoing examples are merely illustrative of some of the features of the invention. The appended claims are intended to claim the invention as broadly as it has been conceived and the examples herein presented are illustrative of selected embodiments from a manifold of all possible embodiments. Accordingly it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. An optical data storage medium, comprising:
a data layer;
a light transmissive layer secured to a surface of a data layer; and
a curable hard coat layer secured to a surface of the light transmissive layer; and the data layer surface is capable of being read, written to, or both read and written to using a laser having a wavelength of less than about 650 nanometers.

2. The optical data storage medium as defined in claim 1, wherein the data layer surface is capable of being read, written to, or both read and written to using a laser having a wavelength of less than about 420 nanometers

3. The optical data storage medium as defined in claim 1, wherein the hard coat layer comprises a radiation curable composition or a thermally curable composition.

4. The optical data storage medium as defined in claim 3, wherein the radiation curable composition is responsive to one or more of ultra-violet radiation, electron-beam radiation, corona radiation, or plasma.

5. The optical data storage medium as defined in claim 3, wherein the hard coat layer comprises one or more of an acrylate, a urethane, an oxirane, a silicone, a melamine polyol, a polyimide, or a combination of two or more thereof.

6. The optical data storage medium as defined in claim 1, wherein the hard coat layer is free of polycarbonate.

7. The optical data storage medium as defined in claim 1, wherein the hard coat layer comprises one or more additives.

8. The optical data storage medium as defined in claim 1, wherein the hard coat comprises compatibilized and passivated silica.

9. The optical data storage medium as defined in claim 1, wherein the hard coat comprises one or both of partially or fully condensed polyhedral oligosilsesquioxane.

10. The optical data storage medium as defined in claim 1, wherein the hard coat comprises one or more of aluminum silicate, magnesium silicate or calcium silicate.

11. The optical data storage medium as defined in claim 1, wherein the data layer comprises one or more of metal oxides, silicone oxide, rare earth element transition metal alloys, nickel, cobalt, chromium, tantalum, platinum, terbium, gadolinium, iron, boron, organic dyes, inorganic phase change compounds, phase change chalcogenide alloy, or a combination of two or more thereof.

12. The optical data storage medium as defined in claim 1, wherein the light transmissive layer comprises a polycarbonate.

13. The optical data storage medium as defined in claim 12, further comprising an adhesive layer securing the light transmissive layer to the data layer.

14. The optical data storage medium as defined in claim 1, wherein the hard coat layer has an average thickness in a range of greater than about 10 microns.

15. The optical data storage medium as defined in claim 1, wherein the hard coat layer has an average thickness in a range of from about 1 micron to about 10 microns.

16. An optical data storage medium as defined in claim 1, wherein the curable hard coat layer is cured.

17. The optical data storage medium as defined in claim 16, wherein the hard coat layer has an average birefringence of about 30 nanometers.

18. The optical data storage medium as defined in claim 16, wherein the hard coat layer has a hardness value that is in a range of greater than about 0.4 Giga Pascals measured at an indentation of 100 microNewtons.

19. The optical data storage medium as defined in claim 16, wherein the hard coat layer has a modulus value that is in a range of greater than about 1 Giga Pascal measured at an indentation of 100 microNewtons.

20. The optical data storage medium as defined in claim 16, wherein the optical data storage medium exhibits a radial tilt change value of less than about 0.5 degree measured at a radius of 55 millimeters after 96 hours at 80 degree Celsius.

21. The optical data storage medium as defined in claim 16, wherein the optical data storage medium exhibits a radial tilt change value of less than or equal to about 0.35 degree measured at a radius of 55 millimeters after 10 hours in a 90 percent relative humidity environment.

22. The optical data storage medium as defined in claim 16, wherein the hard coat layer has a scratch resistance sufficient to result in a scratch area of less than about 40,000 square microns at a normal force of 200 microNewtons.

23. The optical data storage medium as defined in claim 16, wherein the hard coat layer has a coefficient of friction that is in a range of less than about 0.4 at a normal force of 300 microNewtons.

24. An optical data storage medium, comprising:
a data layer;
a light transmissive layer secured to a surface of a data layer; and
a curable hard coat layer secured to a surface of the light transmissive layer, wherein the hard coat layer comprises a radiation curable or a thermally curable silicone composition and the data layer surface is capable of being read, written to, or both read and written to using a laser, wherein the laser has a wavelength of less than about 420 nanometers;
wherein the hard coat layer has an average thickness in a range of less than about 10 microns.

25. A method, comprising:
securing a light transmissive layer to a data layer;
securing a curable hard coat layer directly to a light transmissive layer; and
curing the hard coat layer.

26. The method as defined in claim 28, wherein curing the hard coat layer forms an optical data storage medium, and the method further comprising reading, writing to, or both reading and writing to the data layer using a laser, wherein the laser has a wavelength of less than about 420 nanometers.
